(19) United States
(12) Patent Application Publication
(10) Pub. No.: US 2009/0031145 A1
(43) Pub. Date: Jan. 29, 2009

(54) DATA PROCESSING APPARATUS, DATA PROCESSING SYSTEM, AND CONTROL METHOD THEREFOR

(75) Inventor: Masashi NISHIYAMA, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/142,043

(22) Filed: Jun. 19, 2008

(30) Foreign Application Priority Data
Jul. 26, 2007 (JP) 2007-194561

(51) Int. Cl. H04L 9/06

(52) U.S. Cl. 713/193

(57) ABSTRACT

A data processing apparatus capable of using, without change, a password used at the time of backup as a password at the time of restoration to thereby realize backup and restoration which are high in security and user-friendliness. Upon being backed up into an external storage medium, data stored in a box in the data processing apparatus and protected by password information is encrypted with an encryption key generated based on the password information and is stored into the external storage medium. Upon restoration of the encrypted data from the external storage medium to a multifunction peripheral, password information input by a user is set as a new password, and the data decrypted with a decryption key generated based on the password information is protected with the new password.

### BACKGROUND OF THE INVENTION

1. Field of the Invention

The present invention relates to a data processing apparatus with which document data and other data can easily be backed up and restored, and relates to a data processing system and a control method therefor.

2. Description of the Related Art

As a document processing apparatus for handling document data, there is known a multifunction peripheral with integrated scanning, printing, fax, network communication, and document data storing functions. In an ordinary multifunction peripheral, plural pieces of document data generated from original documents can be stored (accumulated) by the document data storage function (hereinafter referred to as the “box function”). From among pieces of document data stored by the box function, desired document data can selectively be retrieved and output by the printing, fax, or network communication function.

Since the multifunction peripheral is commonly used by plural users, it is preferable that an information protection function be provided in the multifunction peripheral. Thus, a method has been proposed in which document data are classified and stored into plural boxes, and a password is used to limit access to the boxes (hereinafter referred to as “password protection for boxes”) (see, for example, Japanese Laid-open Patent Publication No. 11-196245).

In addition, upon replacement of a multifunction peripheral with a new one, document data stored by the box function should preferably be transferred to the new multifunction peripheral. To this end, there is known a data backup restoration method using a portable medium or a personal computer connected via a network to the multifunction peripheral. However, this method has a problem for example that data stored in a backup destination storage unit can improperly be accessed by a malicious user, unlike the case of a multifunction peripheral capable of limiting access from such a user. Thus, there has been proposed a method for encrypting data with an encryption key to protect the data from being improperly accessed from a third party not having the encryption key (see for example, Japanese Laid-open Patent Publication No. 11-196245).

For password protection of boxes each provided for a user or a user group of a multifunction peripheral, which is commonly used by plural users, encryption and decryption keys for encryption and decryption of data in the boxes must be input and managed. The above described prior art method, though capable of improving security, requires a laborious task and is poor in operability.

In addition, immediately after the replacement of a multifunction peripheral with a new one, passwords are not registered in the new multifunction peripheral, and hence the encrypted backup data cannot be decrypted with the passwords. As a result, a laborious task such as password setting must be made prior to restoration, resulting in deteriorated operability.

### SUMMARY OF THE INVENTION

The present invention provides a data processing apparatus capable of using, without change, password information used at the time of backup of document data or other data as password information at the time of restoration to thereby realize backup and restoration which are high in security and user-friendliness, and provides a data processing system and a control method therefor.

According to a first aspect of the present invention, there is provided a data processing apparatus comprising a storage unit adapted to store plural pieces of data, a protection unit adapted to password protect at least part of the plural pieces of data stored in the storage unit with password information, a backup unit adapted to cause the plural pieces of data stored in the storage unit to be stored into a storage medium, the backup unit being adapted to encrypt the at least part, which is password protected, of the plural pieces of data with an encryption key generated based on the password information and transmit the encrypted data to the storage medium for storage therein, a readout unit adapted to read out the plural pieces of data stored in the storage medium, and a restoration unit adapted to cause the storage unit to store the plural pieces of data read out by the readout unit, the restoration unit being adapted to decrypt the at least part, which is encrypted with the encryption key, of the plural pieces of data read out from the storage medium with a decryption key generated based on input password information corresponding to the password information, wherein the protection unit password-protects the decrypted data with the input password information.

According to a second aspect of this invention, there is provided a data processing system including a first data processing apparatus and a second data processing apparatus, comprising a first storage unit in the first data processing apparatus adapted to store plural pieces of data, a protection unit in the first data processing apparatus adapted to password protect at least part of the plural pieces of data stored in the first storage unit with password information, a backup unit in the first data processing apparatus adapted to cause the plural pieces of data stored in the first storage unit to be stored into a storage medium, the backup unit being adapted to encrypt the at least part, which is password protected, of the plural pieces of data with an encryption key generated based on the password information and transmit the encrypted data to the storage medium for storage therein, a readout unit in the second data processing apparatus adapted to read out the plural pieces of data stored in the storage medium, and a restoration unit in the second data processing apparatus adapted to cause a second storage unit included in the second data processing apparatus to store the plural pieces of data read out by the readout unit, the restoration unit being adapted to decrypt the at least part, which is encrypted with the encryption key, of the plural pieces of data read out from the storage medium with a decryption key generated based on input password information corresponding to the password information, wherein the protection unit password-protects the decrypted data with the input password information.

According to a third aspect of this invention, there is provided a control method for the data processing system according to the second aspect of this invention.

With this invention, at the time of backup of data such as document data, data, if password-protected, is encrypted with an encryption key generated based on password information used for password protection, and is transferred to and stored in a storage medium. At the time of restoration of data, data read out from the storage medium, if encrypted, is decrypted with a decryption key generated based on input password information. The decrypted data is protected with the input password information. As a result, the password information used at the time of backup can be used without change as a password at the time of restoration, making it possible to realize backup and restoration which are high in security and user-friendliness.

Further features of the present invention will become apparent from the following description of an exemplary embodiment with reference to the attached drawings.

### BRIEF DESCRIPTION OF THE DRAWINGS

FIG. 1 is a conceptual view for explaining a backup restoration method implemented by a data processing apparatus according to one embodiment of this invention;

FIG. 2 is a view schematically showing the electrical construction of a first multifunction peripheral shown in FIG. 1;

FIG. 3 is a view showing an example of the functional construction of the first multifunction peripheral;

FIG. 4 is a view showing an example of box setting information for each of the first and second multifunction peripherals;

FIG. 5 is a view showing an example of document data attribute information for a box;

FIG. 6 is a view showing an example of directories structured on an external storage medium;

FIGS. 7A and 7B are a flowchart showing an example of the flow of operation of the first multifunction peripheral at data backup;

FIGS. 8A and 8B are a flowchart showing an example of the flow of operation of the second multifunction peripheral at data restoration;

FIGS. 9A and 9B are a flowchart showing an example of the flow of operation of the second multifunction peripheral at restoration of encrypted document data; and

FIG. 10 is a flowchart showing an example of the flow of operation of the second multifunction peripheral when a password for box setting information is set by a system administrator.

### DETAILED DESCRIPTION OF THE PREFERRED EMBODIMENT

The present invention will now be described in detail below with reference to the drawings showing a preferred embodiment thereof.

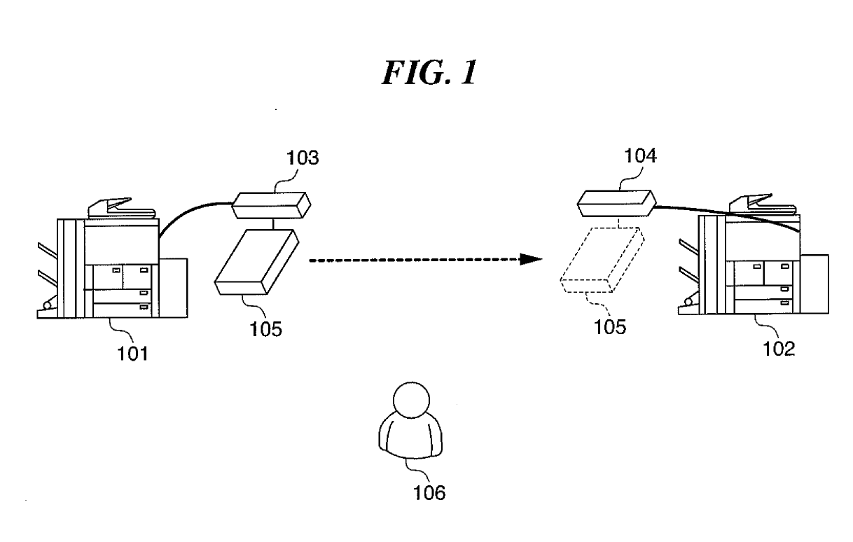

FIG. 1 conceptually explains a backup restoration method, which is implemented by a data processing apparatus according to one embodiment of this invention.

The data processing apparatus of this embodiment includes a multifunction peripheral having scan, printing, fax, network communication, and document data storage functions, etc. Reference numeral 101 denotes a first multifunction peripheral which is an object to be replaced, and reference numeral 102 denotes a second multifunction peripheral which is newly installed. Upon replacement of the first multifunction peripheral 101 with the second multifunction peripheral 102, image processing-related information (hereinafter referred to as data) such as document data stored in the first multifunction peripheral 101 are backed up and restored into the second multifunction peripheral 102.

The first and second multifunction peripherals 101, 102 are ready for USB (universal serial bus) connection, and USB adapters 103, 104 are respectively connected to the first and second multifunction peripherals for being used to establish connection with an external storage medium. By a worker 106 for replacement work, an external storage medium 105 such as a removable HDD is connected to the USB adapter 103 of the first multifunction peripheral 101, and an operation is carried out of causing data stored in first the multifunction peripheral 101 to be stored as backup data into the external storage medium 105. Subsequently, the second multifunction peripheral 102 is newly installed, the external storage medium 105 is connected to the USB adapter 104 connected to the second multifunction peripheral 102, and the backup data stored in the external storage medium 105 is restored into the second multifunction peripheral 102.

In this embodiment, there will be described a case where the data is backed up from the first multifunction peripheral 101 and restored into the second multifunction peripheral 102 as shown in FIG. 1. However, the backup data may be restored into the first multifunction peripheral 101 or into a multifunction peripheral other than the first and second multifunction peripherals 101, 102.

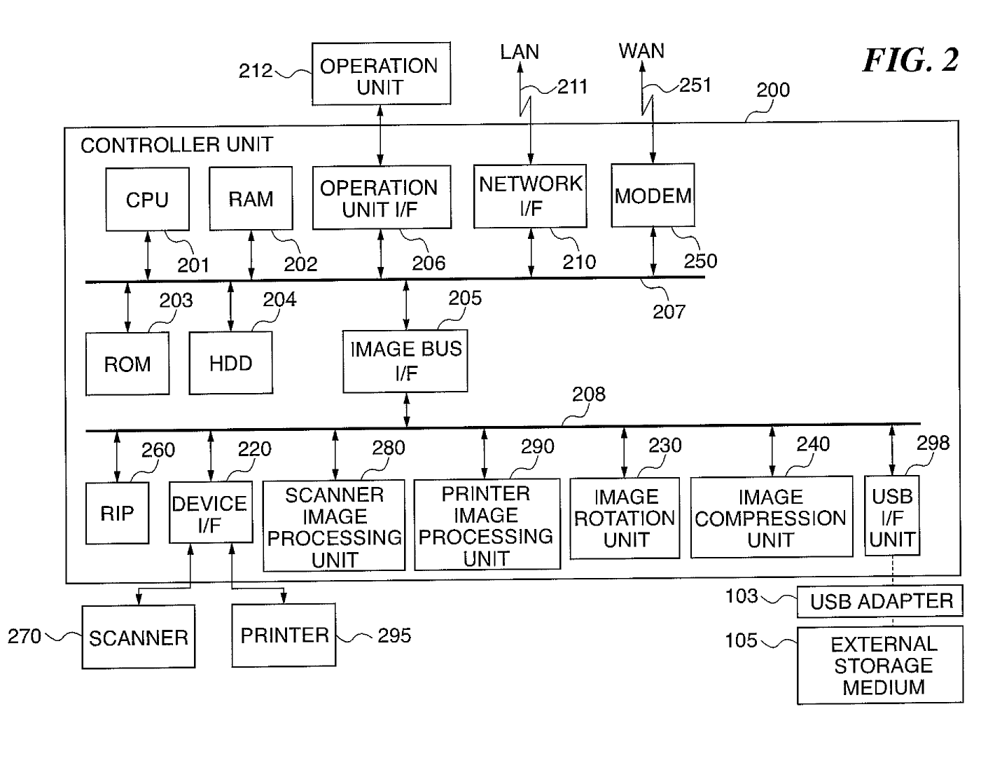

FIG. 2 schematically shows the electrical construction of the first multifunction peripheral 101 in FIG. 1. In this embodiment, the second multifunction peripheral 102 is the same in construction as the first multifunction peripheral 101, and therefore, only the first multifunction peripheral 101 will be described by way of example.

A controller unit 200 is connected to a scanner 270 as an image input device and a printer 295 as an image output device. By being connected to a LAN 211 and a public line (WAN) 251, the controller unit 200 controls input and output of image information and device information.

In the controller unit 200, a CPU 201 is a controller for controlling the entire multifunction peripheral. A RAM 202 is a system work memory for operation of the CPU 201 and an image memory for temporal storage of image data. A ROM 203 is a boot ROM in which a system boot program is stored. An HDD 204 is a large-capacity storage unit such as a hard disk drive (HDD), in which system software, image data, etc. are stored.

An operation unit I/F 206 is an interface unit for an operation unit (UI) 212 having a touch panel, etc., and is adapted to supply the operation unit 212 with image data to be displayed thereon. The operation unit I/F 206 supplies the CPU 201 with information, which is input from the operation unit 212 by a user of the multifunction peripheral.

A network I/F 210 is connected to the LAN 211 for input and output of information. A modem 250 is connected to the public line 251 for input and output of information. The above described devices of the controller unit 200 are on a system bus 207.

An image bus I/F 205 is an interface through which the system bus 207 is connected to an image bus 208 adapted to transfer image data at a high speed. The image bus I/F 205 is a bus bridge for converting data structure. The image bus 208 is implemented for example by a PCI bus or IEEE 1394.

The following is a description of devices which are on the image bus 208. A raster image processor (RIP) 260 decompresses PDL codes into bitmap data. A device I/F 220 connects the controller unit 200 with the scanner 270 and the printer 295.

A scanner image processing unit 280 performs correction, modification and editing on input image data. A printer image processing unit 290 performs printer correction, resolution conversion, etc. on printout image data. An image rotation unit 230 carries out rotation of image data. An image compression unit 240 carries out JPEG compression/decompression processing on multi-valued image data and JBIG, MMR, or MH compression/decompression processing on binary image data.

A USB I/F unit 298 is connected via the USB adapter 103 to the external storage medium 105 for data transfer between the HDD 204 and the external storage medium 105.

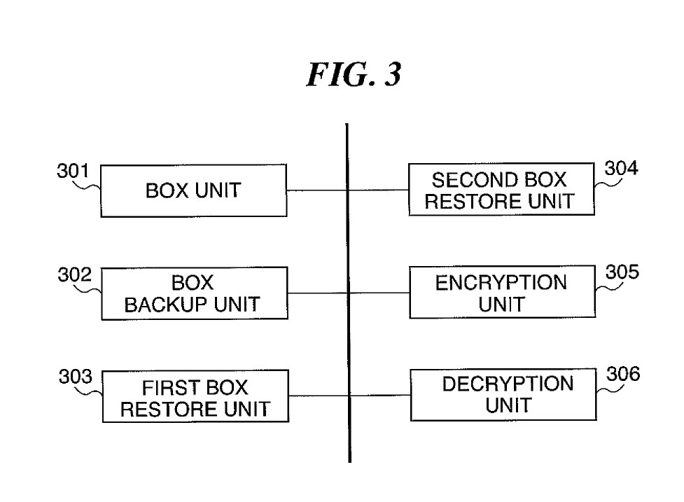

FIG. 3 shows an example of the functional construction of the first multifunction peripheral 101. The second multifunction peripheral 102 is the same in functional construction as the first multifunction peripheral 101, and therefore a description thereof will be omitted. The desired functions of various functional units shown at 301 to 306 in FIG. 3 are achieved by software modules or by software that cooperates with hardware. The software modules are stored in the HDD 204 and loaded into the RAM 202 for being executed by the CPU 201.

Specifically, the multifunction peripheral 101 includes a box unit 301, a box backup unit 302, a first box restore unit 303, a second box restore unit 304, an encryption unit 305, and a decryption unit 306.

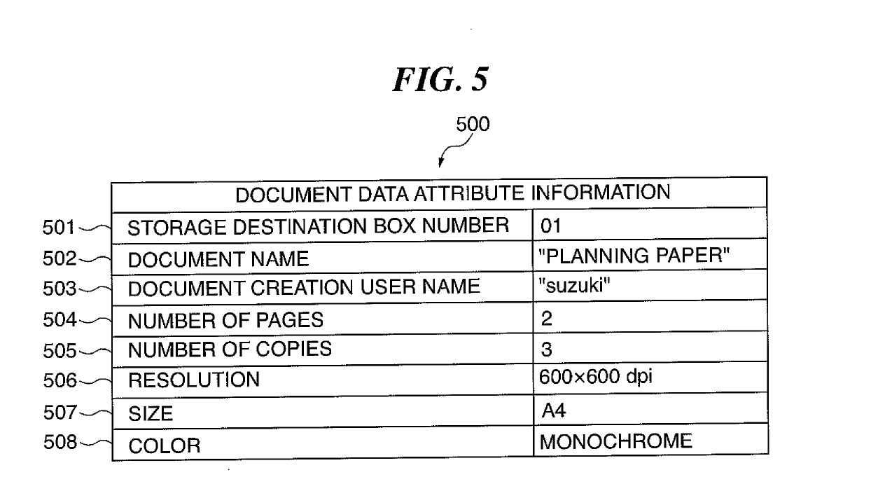

The box unit 301 provides the multifunction peripheral with a file server function, and causes the HDD 204 to store (accumulate) document data. The document data include image data corrected, modified or edited by the scanner image processing unit 280, and attribute information indicating the attribute of the image data. As the attribute information, there may be mentioned document name of document data, number of pages, name of document creation user, as described later with reference to FIG. 5. The attribute information also includes pieces of information representing the contents of processing on image data. Specifically, the pieces of information include designation information (such as for example, monochrome/color designation and double-side/single-side designation) for use when each page is output.

The box unit 301 has a box function of sorting and storing (accumulating) pieces of document data into plural folders provided in the HDD 204. These folders correspond to directories (storage regions) in a hierarchical directory. Each folder serves as a box capable of storing plural pieces of document data. Since the multifunction peripheral is commonly used by plural users, the box unit 301 (protection unit) is adapted to protect pieces of document data in each box by a password-information-based access limiting function and set the password information being used. The password information is set and input from the operation unit 212. Data in the boxes each protected by the password information cannot be referred to unless the password information is input from the operation unit 212.

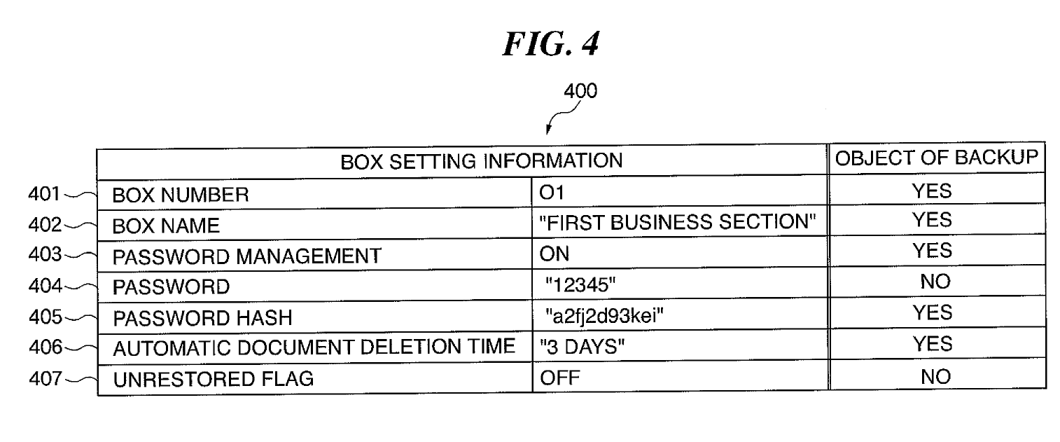

The box backup unit 302 transfers the document data stored (accumulated) by the box unit 301, i.e., the document data in the boxes, into the external storage medium 105 connected to the USB adapter 103, and causes the storage medium 105 to store (back up) the transferred data therein. The box backup unit 302 also transmits box setting information associated with the document data to the external storage medium 105, and causes the transferred information to be stored therein. The image information including the document data and the box setting information is transferred by the box backup unit 302 in accordance with an instruction from the operation unit 212. The instruction from the operation unit 212 becomes executable after completion of authentication of a system administrator password. An example of one of pieces of box setting information for each multifunction peripheral 101 or 102 is shown in FIG. 4.

As shown in FIG. 4, box setting information 400 is comprised of various pieces of setting information contained in items “box number” 401 to “unrestored flag” 407. In the item “box number” 401, box number information (for example, “01”) uniquely assigned to each box is retained. In the item “box name” 402, box name information (for example, “first business section”) is retained. In the item “password management” 403, password management information indicating whether the box is password-protected is retained. If the password management information in the item “password management” 403 is “ON”, it is indicated that the box is password-protected. If the password management information is “OFF”, the box is not password-protected. In the item “password” 404, password information (for example, “12345”) is retained.

Pieces of information in the items “box number” 401 to “password management” 403 are objects of backup (i.e., setting information “YES” is stored in a relevant item “object of backup”). On the other hand, the password information stored in the item “password” 404 is not an object of backup (i.e., setting information “NO” is stored in the item “object of backup”). If the password information per se is backed up into the external storage medium 105, it can be read by a third party improperly accessing to the external storage medium 105. To obviate this, in the embodiment, the password information per se is not backed up but a hash value thereof is backed up.

Specifically, the hash value (for example, “a2fj2d93kei”) determined from the password information by a one-way function is retained in the item “password hash” 405. Since being necessary information for the second box restore unit 304, the hash value in the item “password hash” 405 is an object of backup.

In the item “automatic document deletion time” 406, automatic deletion time information (for example, “three days”) for the document data in the box is retained. In the item “unrestored flag” 407, flag information indicating whether unrestored data exists in the box is retained. If the flag information is “ON”, it is indicated that data for which restoration processing has not been completed (i.e., unrestored data) exists in the box. If the flag information is “OFF”, there is no unrestored data in the box. The flag information is not an object of backup.

FIG. 5 shows an example of one of pieces of document data attribute information in a box. The document data attribute information is an object of backup.

Document data attribute information 500 is comprised of plural pieces information retained in items “storage destination box number” 501 to “color” 508. In the item “storage destination box number” 501, information (for example, “01”) representing a box number of a destination to which document data is to be stored is retained. In the item “document name” 502, information (for example, “planning paper”) indicating a name of the document data is retained. In the item “document creation user name” 503, information (for example, “suzuki”) representing a user who created the document data is retained. In the item “number of pages” 504, information (for example, “2”) representing the number of pages of the document data is retained. In the item “number of copies” 505, information (for example, “3”) indicating the number of output copies of the document data is retained as the designation information. In the item “resolution” 506, information (for example, “600×600 dpi”) indicating the resolution of the document data is retained. In the item “size” 507, information (for example, “A4”) indicating the size of the document is retained. In the item “color” 508, information (for example, “monochrome”) indicating the color in which the document data is to be output is retained.

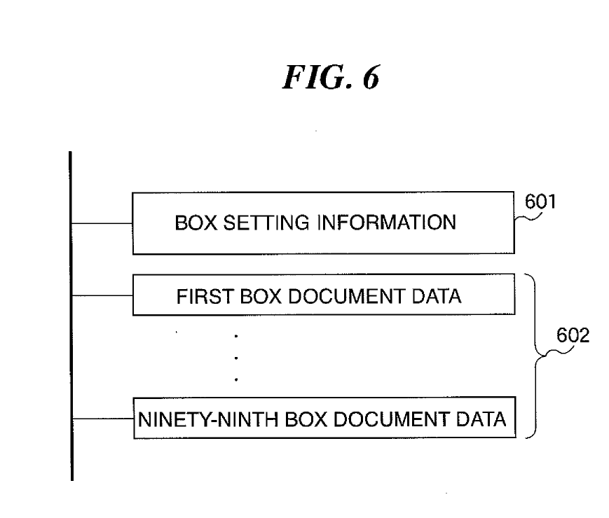

FIG. 6 shows an example of directories (folders) structured on the external storage medium 105.

In a directory “box setting information” 601, backup data of plural pieces of box setting information are stored. In each of directories “first box document data” 602 to “99th box document data” 602, backup data of pieces of document data stored in a corresponding box of the multifunction peripheral are stored. Each document data includes the document data attribute information as shown in FIG. 5. The pieces of data stored in the directories are encrypted as described above.

Referring to FIG. 3 again, the first box restore unit 303 is adapted to re-register pieces of backup data stored in the external storage medium 105 into boxes in the multifunction peripheral 101 or 102. The re-registration processing by the unit 303 is implemented in accordance with an instruction from the operation unit 212. The instruction becomes executable after completion of the password-based authentication by the system administrator. First, encrypted document data is decrypted by the decryption unit 306 with the password used in the authentication by the system administrator. Next, the decrypted box setting information is subjected to the re-registration processing. Then, the document data is re-registered. On the other hand, document data encrypted at backup with an encryption key based on password information retained in the item “password” 404 of the box concerned is not re-registered into the box, but is stored in the HDD 204.

The second box restore unit 304 is adapted to re-register the backup data of document data stored in password-protected boxes, among the backup data in the external storage medium 105, into corresponding boxes of the multifunction peripheral. When a box for which the setting information retained in the item “unrestored flag” 407 of the box setting information is “ON” is accessed, the second box restore unit 304 causes a password input screen to be displayed on the operation unit 212. When password information is input by the user, a hash value of the input password information is generated. The generated hash value is compared with a hash value retained in the item “password hash” 405 of the box concerned. If these hash values are equal to each other, unrestored document data in the box stored in the HDD 204 is decrypted by the decryption unit 306 with the input password information. Then, re-registration processing is carried out to register the decrypted document data into the box. In addition, the input password information is set (retained) in the item “password” 404 of the box. It should be noted that the first and second box restore units 303, 304 may be integrated into one unit.

When pieces of document data and box setting information are transferred by the box backup unit 302 to the external storage medium 105, the encryption unit 305 encrypts part or all the data to be backed up. The encryption is performed with an encryption key generated based on password character string information. Since the encryption processing is implemented using a known technique, a description thereof is omitted.

At the data backup, document data in each password-protected box is encrypted by the encryption unit 305 with password information for the box. The document data in a box not password-protected remains in the form of plain text at that time. Then, all the pieces of data to be backed up are encrypted by the encryption unit 305 based on a password input by the system administrator. As a result, pieces of document data in password-protected boxes are subjected to encryption processing twice.

The decryption unit 306 is provided to correspond to the encryption unit 305 and adapted to decrypt pieces of document data and box setting information received from the external storage medium 105. The decryption is implemented using a decryption key generated based on password character string information. Since the decryption processing is implemented using a known technique, a description thereof is omitted.

Next, operation of the multifunction peripheral 101 or 102 at the data backup will be described. In the following, a case will be described in which data in the multifunction peripheral 101 is backed up into the external storage medium 105.

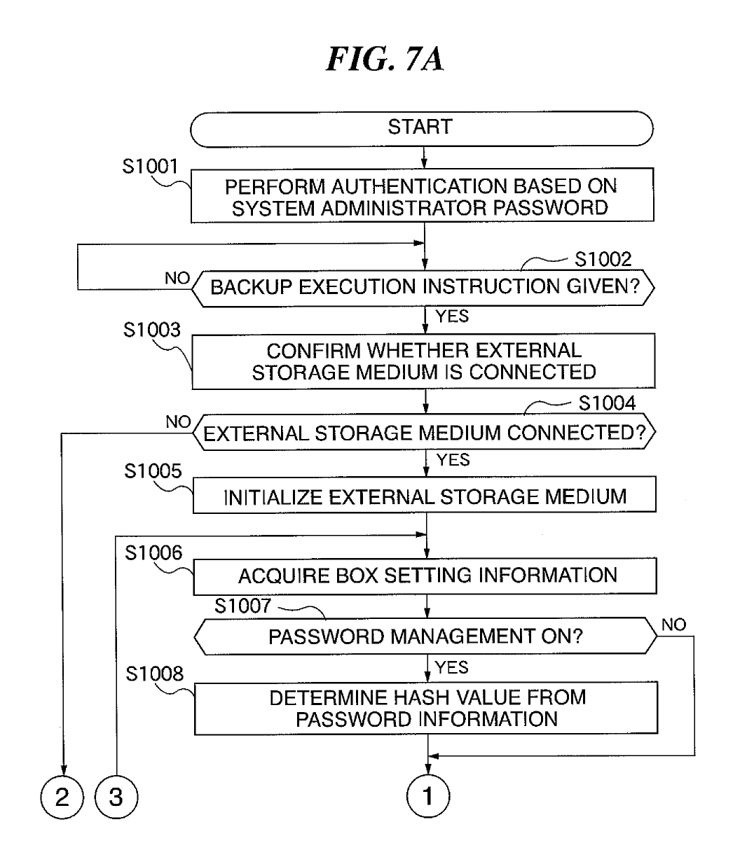

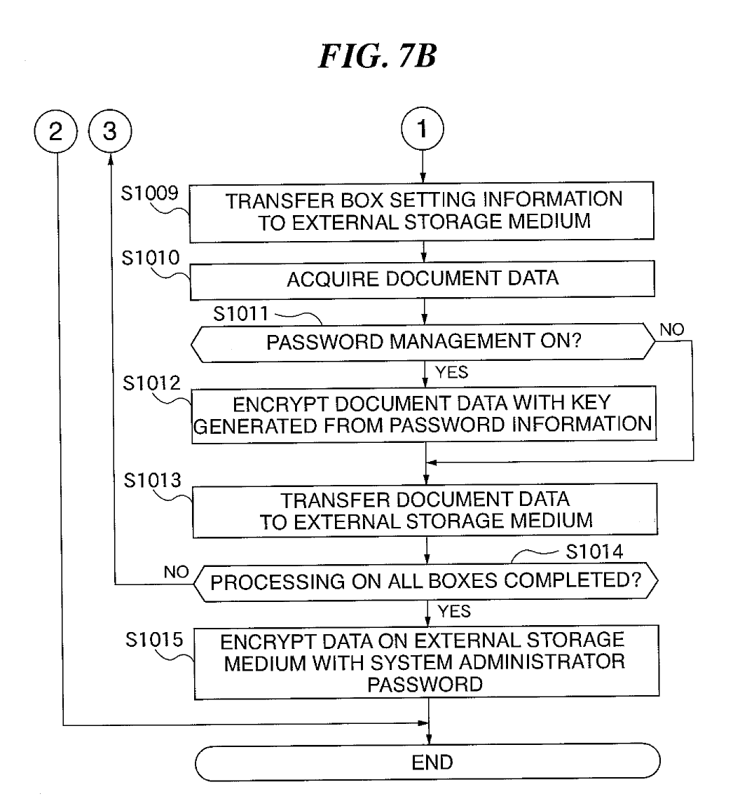

FIGS. 7A and 7B show in flowchart an example of the flow of operation of the multifunction peripheral 101 at the data backup. The processing in this flowchart is implemented by the CPU 201 of the multifunction peripheral 101.

As shown in FIGS. 7A and 7B, the multifunction peripheral 101 performs authentication based on a system administrator password input by the system administrator or the like (step S1001), causes a backup execution button to be displayed on the operation unit 212, and shifts to a backup executable state. Next, when a backup execution instruction is given (YES to step S1002), the box backup unit 302 confirms whether or not the external storage medium 105 is connected to the USB I/F unit 298 via the USB adapter 103 or the like (step S1003).

In step S1004, it is determined whether or not the external storage medium 105 is connected to the USB adapter 103. If the external storage medium 105 is not connected (No to step S1004), the present processing is completed. Alternatively, the flowchart may not be completed when the external storage medium 105 is not connected to the USB adapter 103. In that case, a message for encouraging the operator to connect the external storage medium may be displayed on the operation unit 212, whereupon the flow may return to step S1003. On the other hand, if the external storage medium 105 is connected, the external storage medium 105 is initialized, and directories as shown in FIG. 6 are structured on the external storage medium 105 (step S1005).

Next, box setting information for one box is acquired from the box in the HDD 204 (step S1006). If setting information in the item “password management” 401 of the acquired box setting information is “OFF” (NO to step S1007), the flow proceeds to step S1009.

If, on the other hand, the setting information in the item “password management” 403 is “ON” (YES to step S1007), a hash value is determined by a one-way function from password information retained in the item “password” 404 of the acquired box setting information (step S1008). The calculated hash value is retained in the item “password hash” 405 of the box setting information.

In step S1009, the box setting information is transferred to and stored in the directory “box setting information” 601 on the external storage medium 105. The box setting information transferred to the directory 601 includes setting information on the items “box number” 401, “box name” 402, “password management” 403, “password hash” 405, and “automatic document deletion time” 406, other than the setting information on the item “object of backup”.

Next, document data corresponding to the box setting information is acquired (step S1010). If the setting information of the item “password management” 403 of the box setting information is “ON” (YES to step S1011), the document data is encrypted by the encryption unit 305 with an encryption key generated based on the password information retained in the item “password” 404 (step S1012). Then, the encrypted document data is transferred to and stored in the corresponding directory 601 on the external storage medium 105 (step S1013).

On the other hand, if it is determined in step S1011 that the setting information in the item “password management” 403 of the box setting information is set at “OFF”, the acquired document data is not encrypted but transferred to and stored in the directory 601 on the external storage medium 105 (step S1013).

In step S1014, it is determined whether or not the above described series of processing has been carried out on all the boxes. If the processing for all the boxes has not been completed (NO to step S1014), the flow returns to step S1006, and the processing in step S1006 and the subsequent steps is carried out for the remaining box or boxes.

On the other hand, if the processing for all the boxes has been completed (YES to step S1014), data stored in each directory on the external storage medium 105 are encrypted with the system administrator password input in step S1001 (step S1015). The password for encryption in step S1015 may be one which is other than the password input in step S1001.

Next, operation of the multifunction peripheral 101 or 102 at the data restoration will be described. The following is a description of a case in which data in the external storage medium 105 is restored into the multifunction peripheral 102.

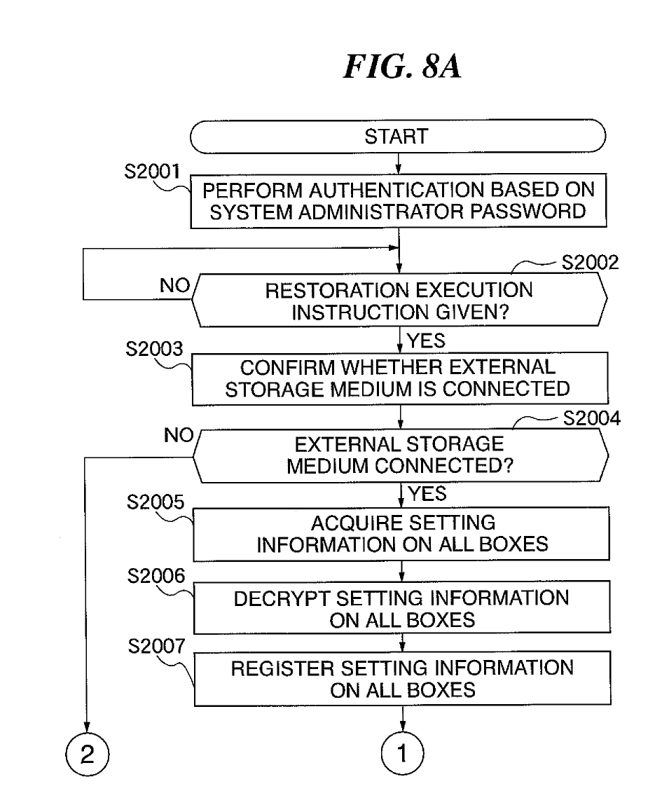

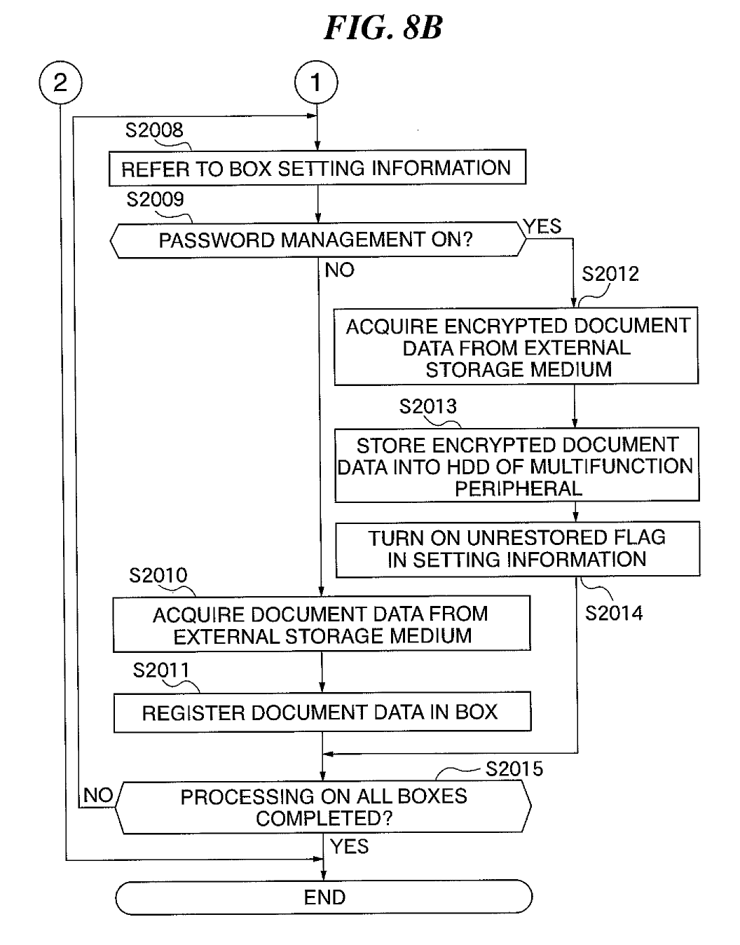

FIGS. 8A and 8B show an example of the flow of operation of the multifunction peripheral 102 at the data restoration. The processing in the flowchart is implemented by the CPU 201 of the multifunction peripheral 102.

As shown in FIGS. 8A and 8B, the CPU 201 of the multifunction peripheral 102 performs authentication based on a system administrator password input by the system administrator or the like (step S2001), causes a restoration execution button to be displayed on the operation unit 212, and shifts to a state capable of receiving a restoration execution instruction. When receiving the instruction for execution of restoration given by the user from the operation unit 212 (YES to step S2002), the CPU 201 proceeds to step S2003. In step S2003, the first box restore unit 303 confirms whether or not the external storage medium 105 is connected to the USB I/F unit 298 via the USB adapter 103 or the like.

In step S2004, it is determined whether or not the external storage medium 105 is connected. If it is determined that the external storage medium 105 is not connected (NO to step S2004), the present processing is completed. It should be noted that in the case of the external storage medium 105 being unconnected to the USB adapter 103, the present processing may not be completed. In that case, a message to prompt the user to connect the external storage medium may be displayed on the operation unit 212, whereupon the flow may return to step S2003 again. On the other hand, if it is determined in step S2004 that the external storage medium 105 is connected, various pieces of setting information for all the boxes are acquired from the directories 601 structured on the external storage medium 105 (step S2005).

In step S2006, the acquired pieces of setting information of all the boxes are decrypted by the decryption unit 306 with the system administrator password input in step S2001 as a decryption key. It should be noted that if the encryption at the backup is implemented using a password other than the system administrator password, a screen for prompting password input may be displayed on the operation unit 212 to accept the input of password by the administrator.

Next, various pieces of setting information of all the boxes decrypted in step S2006 are stored (registered) into the HDD 204 of the multifunction peripheral 102 (step S2007). The box setting information to be restored include the setting information for the items “box number” 401, “box name” 402, “password management” 403, “password hash” 405, and “automatic document deletion time” 406.

Next, processing for document data restoration is started. First, setting information of one box is referred to (step S2008). If the setting information in the item “password management” 403 of the box setting information referred to is “OFF” (NO to step S2009), the flow proceeds to step S2010. On the other hand, if the setting information in the item “password management” 403 is “ON” (YES to step S2009), the flow proceeds to step S2012.

In step S2010, document data stored in the directory 602 on the external storage medium 105 and corresponding to the box setting information that includes the setting information “OFF” in the item “password management” 403 is acquired as it is, since such document data is not encrypted. Then, the acquired document data is stored (registered) in the box of the multifunction peripheral 102 (step S2011).

In step S2012, the document data (encrypted with the password for the box as an encryption key) stored in the directory 602 of the external storage medium 105 and corresponding to the box setting information that includes the setting information “ON” in the item “password management” 403 is acquired. Then, the encrypted document data is stored into the HDD 204 (step S2013). The storage destination directory for the encrypted document data may be a directory corresponding to the box. Next, the setting information in the item “unrestored flag” 407 of the box setting information is turned “ON” (step S2014). The restoration of the document data of the box is not completed by simply executing the processing in step S2013 because the document data remains being encrypted, which cannot be used by the user. As will be described in detail below, if the setting information in the item “unrestored flag” 407 is turned “ON”, the controller unit 200 is able to identify that the restoration of the box has not been completed. When subsequently accessing to such a box, the user who knows the password for the box is able to complete the restoration processing on the document data stored in the box.

Even if a password is set to a box prior to backup, no password is set at a registration destination box (new multifunction peripheral after replacement). If document data in a password-protected box is backed up and restored without being encrypted in an ordinary technique, the document data is restored into a box which is not password-protected, and as a result, security of the document data cannot be maintained. In view of this, at the time point of step S2013, the document data in the HDD 204 is stored in a state where it remains being encrypted with the password information for the box, thereby maintaining the security of the document data.

In step S2015, it is determined whether or not the above described series of processing has been carried out on all the boxes. If the processing has not been carried out on all the boxes (NO to step S2015), the flow returns to step S2008. Then, the processing in step S2008 and the subsequent steps is implemented on the remaining one or more boxes. On the other hand, if the processing on all the boxes has been completed (YES to step S2015), the present processing is completed.

According to the flowcharts shown in FIGS. 7A to 8B, document data maintained in secret with a password set to folders can be backed up and restored while maintaining the secrecy thereof.

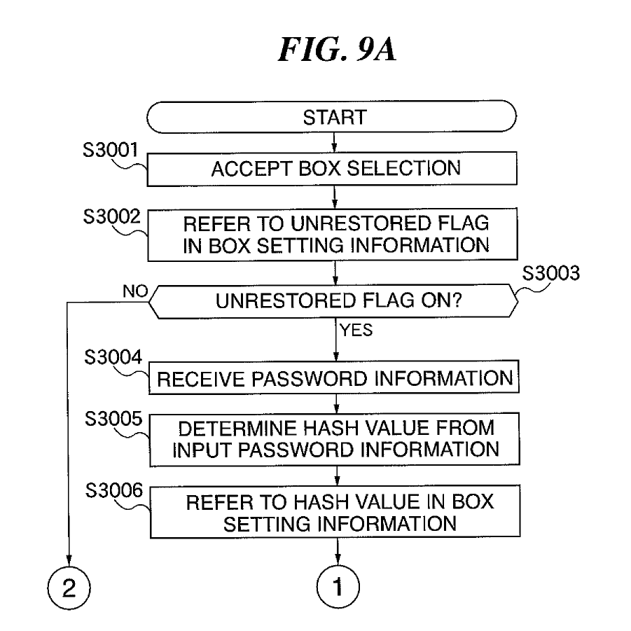

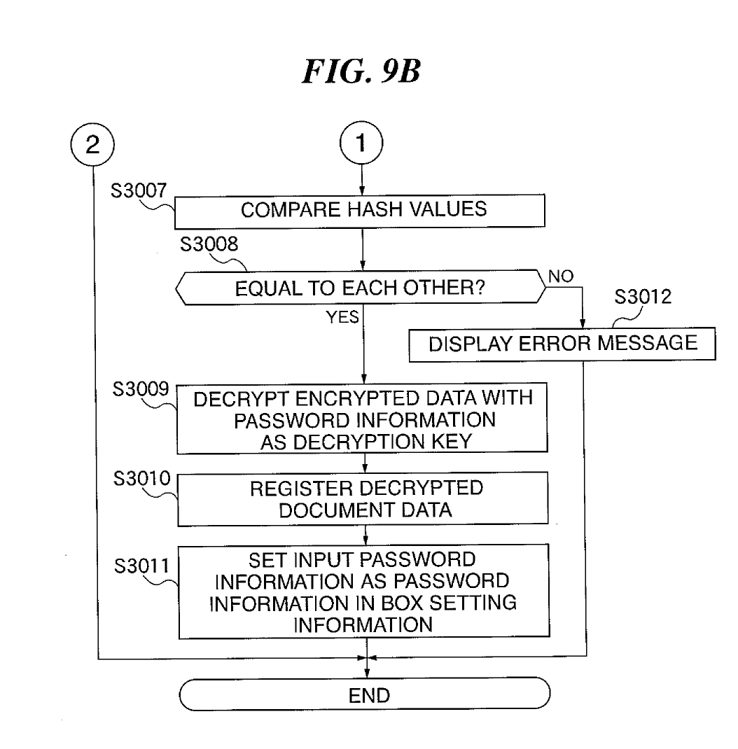

By the restoration processing shown in FIGS. 8A and 8B, the box setting information on all the boxes are restored, and document data stored in boxes which are not password-protected at the time of backup are also restored. On the other hand, document data stored in boxes which are password-protected at the time of backup are not restored. In the following, operation for restoration of document data not restored by the processing of FIGS. 8A and 8B will be described with reference to FIGS. 9A and 9B.

FIGS. 9A and 9B show in flowchart an example of the flow of operation of the multifunction peripheral 102 at the time of restoration of encrypted document data. The processing shown in this flowchart can be implemented by the CPU of the multifunction peripheral 102 after completion of the processing shown in the flowchart of FIGS. 8A and 8B.

As shown in FIGS. 9A and 9B, if a desired box is selected by a user's operation on the operation unit 212, the CPU 201 of the multifunction peripheral 102 accepts the instruction for selection (step S3001). Then, the setting information retained in the item “unrestored flag” 407 in the box setting information corresponding to the selected box is referred to by the box unit 301 (step S3002).

If the setting information in the item “unrestored flag” 407 referred to is “ON” (YES to step S3003), a screen for password input is displayed on the operation unit 212. When the password information is input (step S3004), the second box restore unit 304 determines a hash value from the input password information by a one-way function (step S3005).

Next, a hash value at the time of backup is referred to, which is retained in the item “password hash” 405 for a box whose box setting information includes the “ON” information in the item “unrestored flag” 407 (step S3006). Then, the hash value calculated in step S3005 is compared with the hash value retained in the item “password hash” 405 (step S3007). As a result of the comparison, if it is determined that these hash values are equal to each other (YES to step S3008), the encrypted data stored in the HDD 204 in step S2013 in FIG. 8 is decrypted with the password information input in step S3004 serving as a decryption key (step S3009). Then, the decrypted document data is stored (registered) in the box (step S3010).

Next, the password information input in step S3004 is set as password information in the item “password” 404 of the box setting information (step S3011), whereupon the present processing is completed. As a result, the password-protected box is restored.

If it is determined in step S3008 that the hash value calculated in step S3005 is different from the hash value stored in the item “password hash” 405 of the box setting information (NO to step S3008), an error message is displayed on the operation unit 212 and the restoration is discontinued (step S3012). As described above, if the password input in step S3004 is an improper password, any operations cannot be carried out on the box. On the other hand, operations on the box can be carried out by newly setting password information for the item “password” 440 of the box from the operation unit 212 with the system administrator right.

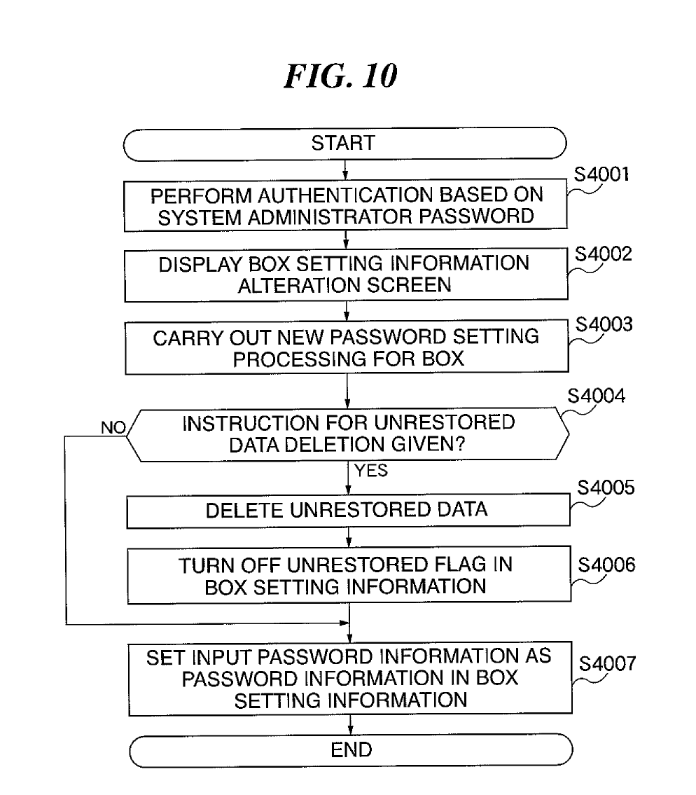

FIG. 10 shows in flowchart an example of the flow of operation of the second multifunction peripheral 102 performed when a password for the box setting information is set by the system administrator. The processing shown in this flowchart is implemented by the CPU 201 of the second multifunction peripheral 102.

As shown in FIG. 10, the multifunction peripheral performs authentication based on the system administrator password input by the system administrator or the like (step S4001). Next, a box setting information alteration screen (not shown) is displayed on the operation unit 212 (step S4002).

Next, new-password setting processing for a box is carried out (step S4003). Without the system administrator right, password information cannot be set for a box having the setting information “ON” in the item “unrestored flag”. If new password information is input to give an alteration instruction, a screen for confirmation of whether unrestored data may be deleted is displayed on the operation unit 212, and it is determined whether or not an instruction for deletion of unrestored data is given (step S4004).

It is determined in step S4004 that the instruction for deletion of unrestored data is not given (NO to step S4004), the flow proceeds to step S4007. On the other hand, if it is determined that the instruction for deletion of unrestored data is given (YES to step S4004), the unrestored data is deleted (step S4005).

Next, the setting information in the item “unrestored flag” 407 of the box setting information is set to be “OFF” (step S4006). In step S4007, the new password information set in step S4003 is set into the item “password” of the box setting information, whereupon the present processing is completed.

As described above, in a case that a password for a box used at the time of backup is forgotten, the box can be made usable by deleting unrestored data and turning “OFF” unrestored flag by the system administrator.

According to the above described embodiment, in a case that image information acquired is password-protected at the time of backup, the image information is encrypted with an encryption key generated based on password information set in box setting information, and the encrypted image information is stored in the external storage medium 105, thereby preventing improper access to data stored in a backup destination storage unit to protect the data. In addition, a laborious task of setting and storing passwords for data to be protected can be omitted.

According to the above described embodiment, in a case that image information stored in the external storage medium 105 is encrypted at the time of restoration, the user is requested to input password information, and the encrypted image information is decrypted with a decryption key generated based on input password information. The input password information is set as new password information to be used to protect the decrypted image information. As a result, a data protection function can be re-structured using the password information input at the time of restoration, thereby omitting a task for setting the data protection function again in a newly replaced multifunction peripheral.

As described above, the password information used for data protection in a multifunction peripheral at the time of backup can be used without change as password information at the time of restoration, whereby backup and restoration which are high in security and user-friendliness can be realized.

It is to be understood that the present invention may also be accomplished by supplying a system or an apparatus with a storage medium in which a program code of software, which realizes the functions of the above described embodiment is stored and by causing a computer (or CPU or MPU) of the system or apparatus to read out and execute the program code stored in the storage medium. In that case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, and a magnetic-optical disk, an optical disk such as a CD-ROM, a CD-R, a CD-RW, a DVD-ROM, a DVD-RAM, a DVD-RW, a DVD+RW, a magnetic tape, a nonvolatile memory card, and a ROM. The program code may be downloaded via a network.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2007-194561, filed Jul. 26, 2007, which is hereby incorporated by reference herein in its entirety.

What is claimed is:

1. A data processing apparatus comprising:
a storage unit adapted to store plural pieces of data;
a protection unit adapted to password protect at least part of the plural pieces of data stored in said storage unit with password information;
a backup unit adapted to cause the plural pieces of data stored in said storage unit to be stored into a storage medium, said backup unit being adapted to encrypt the at least part, which is password protected, of the plural pieces of data with an encryption key generated based on the password information and transmit the encrypted data to the storage medium for storage therein;
a readout unit adapted to read out the plural pieces of data stored in the storage medium; and
a restoration unit adapted to cause said storage unit to store the plural pieces of data read out by said readout unit, said restoration unit being adapted to decrypt the at least part, which is encrypted with the encryption key, of the plural pieces of data read out from the storage medium with a decryption key generated based on input password information corresponding to the password information,
wherein said protection unit password-protects the decrypted data with the input password information.

2. The data processing apparatus according to claim 1, wherein said backup unit encrypts the plural pieces of data stored in said storage unit with an encryption key generated based on a second password and causes the storage medium to store encrypted data.

3. The data processing apparatus according to claim 2, wherein said restoration unit decrypts the plural pieces of data read out by said readout unit with a decryption key generated based on the second password, and causes said storage unit to store decrypted data.

4. The data processing apparatus according to claim 1, wherein said storage unit is provided with a plurality of storage regions in which the plural pieces of data divided into plural groups are stored, and
said protection unit is adapted to password protect data stored in at least part of the plurality of storage regions by password protecting the at least part of the plurality of storage regions.

5. The data processing apparatus according to claim 4, wherein said storage unit is adapted to store document data and plural pieces of setting information for respective ones of the plurality of storage regions.

6. The data processing apparatus according to claim 5, wherein at least one piece of setting information for at least part, which is password protected, of the plurality of storage regions includes password information for use for password protection.

7. The data processing apparatus according to claim 6, wherein said backup unit does not back up the password information contained in the at least one piece of setting information for the at least part of the plurality of storage regions into the storage medium, but backs up at least one hash value obtained from the password information.

8. The data processing apparatus according to claim 7, wherein said readout unit reads out the plural pieces of data in sequence, and
said restoration unit causes the data read out by said readout unit to be stored in the storage unit in a case where a hash value obtained from the input password information is equal to the hash value backed up by said backup unit for the data read out by said readout unit, said restoration unit not causing the data read out by said readout unit to be stored in said storage unit in a case where the hash value obtained from the input password information is not equal to the hash value backed up by said backup unit.

9. A data processing system including a first data processing apparatus and a second data processing apparatus, comprising:
a first storage unit in the first data processing apparatus adapted to store plural pieces of data;
a protection unit in the first data processing apparatus adapted to password protect at least part of the plural pieces of data stored in said first storage unit with password information;
a backup unit in the first data processing apparatus adapted to cause the plural pieces of data stored in said first storage unit to be stored into a storage medium, said backup unit being adapted to encrypt the at least part, which is password protected, of the plural pieces of data with an encryption key generated based on the password information and transmit the encrypted data to the storage medium for storage therein;
a readout unit in the second data processing apparatus adapted to read out the plural pieces of data stored in the storage medium; and
a restoration unit in the second data processing apparatus adapted to cause a second storage unit included in the second data processing apparatus to store the plural pieces of data read out by said readout unit, said restoration unit being adapted to decrypt the at least part, which is encrypted with the encryption key, of the plural pieces of data read out from the storage medium with a decryption key generated based on input password information corresponding to the password information,
wherein said protection unit password-protects the decrypted data with the input password information.

10. A control method for a data processing system which comprises a first data processing apparatus and a second data processing apparatus, wherein the first data processing apparatus includes a first storage unit adapted to store plural pieces of data, a protection unit adapted to password protect at least part of the plural pieces of data stored in the first storage unit with password information, and a backup unit adapted to cause the plural pieces of data stored in the first storage unit to be stored into a storage medium, and wherein the second data processing apparatus includes a readout unit adapted to read out the plural pieces of data stored in the storage medium, and a restoration unit adapted to cause a second storage unit to store the plural pieces of data read out by the readout unit, the control method comprising:
a backup step of encrypting the at least part, which is password protected, of the plural pieces of data with an encryption key generated based on the password information and transmitting the encrypted data to the storage medium for storage therein; and
a restoration step of decrypting the at least part, which is encrypted with the encryption key, of the plural pieces of data read out from the storage medium with a decryption key generated based on input password information corresponding to the password information, and password protecting the decrypted data by the protection unit with the input password information.
